(19) United States
(12) Patent Application Publication
(10) Pub. No.: US 2018/0218569 A1
(43) Pub. Date: Aug. 2, 2018

(54) GAME APPARATUS AND GAME CONTROLLING METHOD

(71) Applicant: SEGA SAMMY CREATION INC., Tokyo (JP)

(72) Inventors: Yudai Takahara, Tokyo (JP); Taiji Sugai, Tokyo (JP)

(21) Appl. No.: 15/538,087

(22) PCT Filed: May 17, 2016
(86) PCT No.: PCT/JP2016/064552

§ 371 Date: Jun. 20, 2017

(51) Int. Cl. G07F 17/32

(52) U.S. Cl. CPC G07F 17/3255; G07F 17/3267; G07F 17/3251; G07F 17/3288; G07F 17/3246; G07F 17/3213

(57) ABSTRACT

A game apparatus possesses a control unit and a storage unit. The control unit is configured to execute a program stored in the storage unit and thereby to realize a lots-drawing function of performing lots-drawing in accordance with a game result of a first game and a granting function of grating a right to continuously play a second game in accordance with a result of lots-drawing, and thereafter in a case where a play result of the second game has satisfied a predetermined condition, granting a right to continuously play the second game a number of times which is not less than a number of times that the second game is continuously played under the right which has been granted at the previous time. The game apparatus provides a game of higher entertaining property.

### CROSS-REFERENCE TO RELATED APPLICATIONS

This application is the U.S. national phase of the International Patent Application No. PCT/JP2016/064552 filed May 17, 2016, the entire content of which is incorporated herein by reference.

### TECHNICAL FIELD

The present disclosure relates to a game apparatus and a game controlling method.

### BACKGROUND

Recently, various game apparatuses have been developed. For example, in Japanese Patent Application Laid-Open No. 2015-024139, a game apparatus which displays part of virtual reels on a display unit and spins them and thereby makes playing of a slot game possible under the control of a computer is disclosed. In such a slot game, the game apparatus spins a plurality of the reels and sequentially stops the respective reels in accordance with an operation of a player, and displays a combination of symbols on the reel on the display unit. Thereafter, the game apparatus grants a privilege to the player on the basis of the kinds and arrangement of the symbols displayed on the display unit.

### SUMMARY

The entertaining property of the game is a major matter of concern for the player and the entertaining property of the game is greatly changed depending on what kind of privilege is granted under which condition.

The present disclosure has been made in view of the above, and the subject thereof is to provide a technique pertaining to the game of higher entertaining property.

A game apparatus in one aspect of the present disclosure is the game apparatus which has possessed a control unit and a storage unit and the control unit is configured to execute a program stored in the storage unit and thereby to realize a lots-drawing function of performing lots-drawing in accordance with a game result of a first game and a granting function of granting a right to continuously play a second game in accordance with a result of the lots-drawing and thereafter in a case where a play result of the second game has satisfied a predetermined condition, granting a right to continuously play the second game a number of times which is not less than a number of times that the second game is played under the right which has been granted at the previous time.

A game controlling method in one aspect of the present disclosure is the game controlling method which is performed by a game apparatus which has possessed a control unit and a storage unit and comprises that the control unit executes a program stored in the storage unit and thereby performs the lots-drawing step of performing lots-drawing in accordance with a game result of a first game and the granting step of granting a right to continuously play a second game in accordance with a result of the lots-drawing and in a case where a play result of the second game has satisfied a predetermined condition, grating a right to continuously play the second game a number of times which is not less than a number of times that the second game is continuously played under the right which has been granted at the previous time.

According to the present disclosure, it is possible to provide a technique relating to a game of higher entertaining property.

### BRIEF DESCRIPTION OF THE DRAWINGS

Various embodiments of the disclosure are illustrated in the drawings, in which:

FIG. 1 is an external perspective view of a game apparatus in one embodiment.

FIG. 2 is a block diagram illustrating main hardware configurations of the game apparatus in one embodiment.

FIG. 3 is a conceptual diagram illustrating an example of a screen to be displayed on a display device in one embodiment.

FIG. 4. Is a conceptual diagram illustrating an example of a screen to be displayed on the display device in one embodiment.

FIG. 5 is a conceptual diagram illustrating an example of a screen to be displayed on the display device in one embodiment.

FIG. 6 is a block diagram illustrating main functional configurations of the game apparatus in one embodiment.

FIG. 7 is a flowchart for describing processing by the game apparatus in one embodiment.

### DETAILED DESCRIPTION

In the following, embodiments of the present disclosure will be described with reference to the drawings. However, the embodiments which will be described in the following are merely illustrative and there is no intention of excluding application of various alterations and techniques which are not clearly described in the following. That is, the present disclosure may be performed by altering it in a variety of ways (combining together the respective embodiment and so forth) within a range not deviating from the gist thereof. In addition, in the following description of the drawings, the same or similar parts are indicated by assigning the same or similar symbols thereto. The drawings are schematic ones and are not always consistent with actual dimensions, ratios and so forth. There are cases where parts that mutual dimensional relations and ratios are different from one another also among the drawings are included.

In the following, a game apparatus and a program in the embodiments of the present disclosure will be described using the drawings.

### External Configuration Example of the Game Apparatus

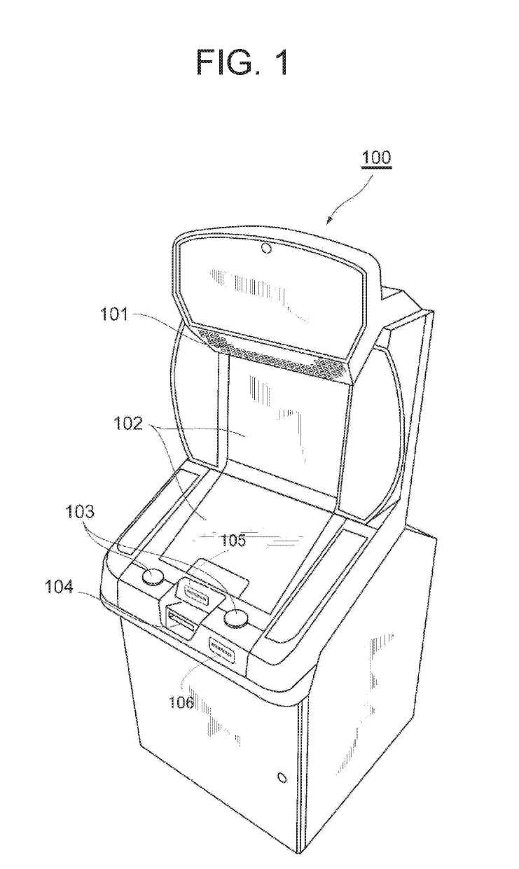

FIG. 1 is an external perspective view of the game apparatus in the embodiment. A game apparatus 100 illustrated in FIG. 1 is the game apparatus to be installed in a casino, an amusement facility and so forth. In the present embodiment, it becomes possible for a player to play a slot game (a reel game) by the game apparatus 100.

As illustrated in FIG. 1, the game apparatus 100 possesses a loudspeaker 101, a plurality of display devices 102, a plurality of operation buttons (in the following, called an “operation input device” 103), a card reading device 104, a bill putting-in device 105, and a ticket ejecting device 106 in appearance. The loudspeaker 101 is sound output means which outputs speech guidance, sound effects and so forth of a game. The display device 102 is configured by two upper and lower display devices and is display means which displays images (for example, a still image, a moving image, a video image and so forth) for expressing or dramatizing the game. The operation input device 103 is configured by the plurality of buttons and the buttons adapted to input instructions from the player into the game apparatus. Incidentally, the operation input device 103 is not limited to such a configuration and may have any configuration if it is the configuration which enables the player to input the instructions. The card reading device 104 is a card reader which reads information out of a card that the player holds. The bill putting-in device 105 is a device which reads bills and tickets which have been put into it. The ticket ejecting device 106 is ticket output means which ejects the card to the player.

The card which is read by the card reading device 104 is a medium in which play information of the player has been stored. It is possible to additionally store, for example, points and so forth which have been acquired depending on a playing situation of the player into the card. Although it is possible for the player to obtain various kinds of service in accordance with the information stored in the card, memory content in the card does not exert influence on a play result.

### Hardware Configuration Example of the Game Apparatus

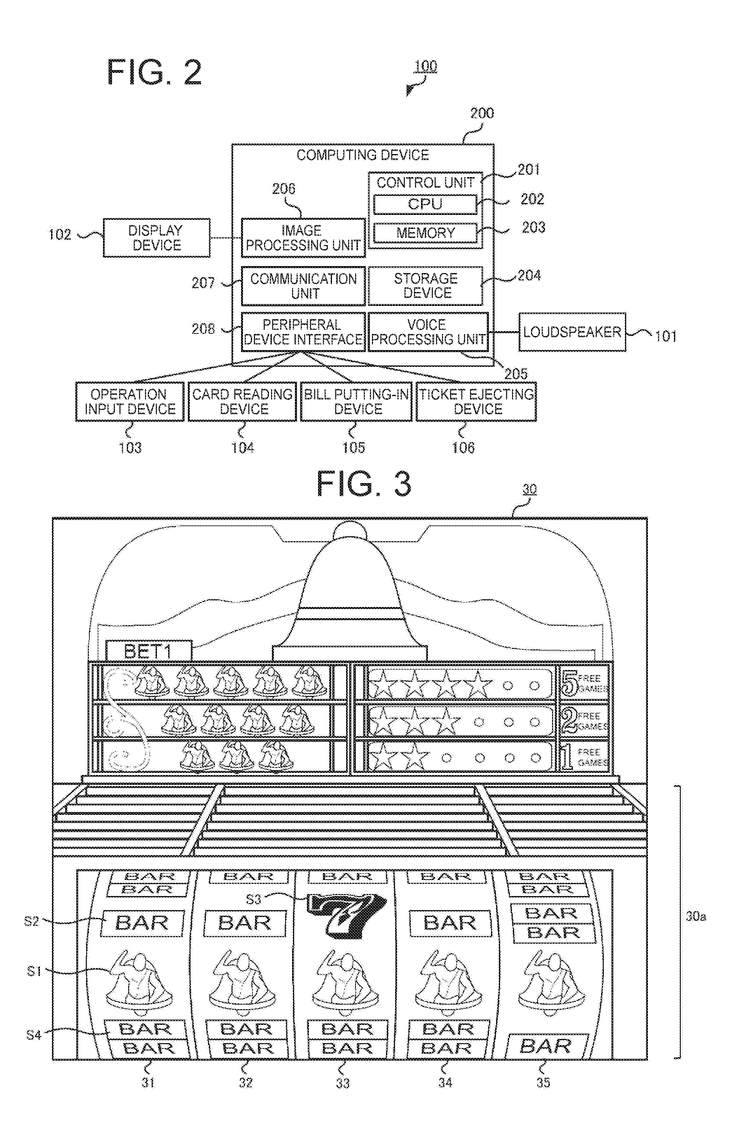

An example of the hardware configurations of the game apparatus 100 will be described with reference to FIG. 2. As illustrated in FIG. 2, the game apparatus 100 possesses a computing device 200, the loudspeaker 101, the display device 102, the operation input device 103, the card reading device 104, the bill putting-in device 105 and the ticket ejecting device 106 as the hardware configurations.

The computing device 200 is a control device which all-inclusively controls the game apparatus 100. The computing device 200 in the present embodiment comprises a control unit 201, a storage device 204, a voice processing unit 205, an image processing unit 206, a communication unit 207, and a peripheral device interface 208 as the main hardware configurations.

The control unit 201 comprises a CPU (Central processing Unit) 202 and a memory 203. For example, the CPU 202 executes a predetermined software program (for example, a game program) which has been stored in the memory 203 and the storage device 204 and so forth and thereby the computing device 200 controls processes and operations of other hardware configurations and functions as means for realizing various functions. That is, the computing device 200 executes the predetermined program under the control of the control unit 201 and thereby realizes a game function in cooperation with other hardware. Incidentally, only the main configurations that the computing device 200 possesses are illustrated in FIG. 2 and the computing device 200 possesses other configurations that a general information processing device possesses.

The storage device 204 is configured by a hard disk and so forth. Data reading and writing are performed on the storage device 204 by the control unit 201. That is, data such as the software program and so forth required for processing in the computing device 200 is written into the storage device 204 and in addition data on a result of processing concerned is written into it. The voice processing unit 205 performs various kinds of sound processing under the control of the control unit 201. The image processing unit 206 performs various kinds of graphics processing under the control of the control unit 201. The communication unit 207 is an interface which makes communication with a server and other game apparatuses possible. The peripheral device interface 208 is an interface which makes communication between the computing device 200 and peripherals such as the operation control device 103, the card reading device 104, the bill putting-in device 105 and the ticket ejecting device 106 and so forth possible.

### Game Content Example

Next, one example of the content of a game playing of which is made possible for a user by the game apparatus 100 of the present embodiment will be described. The game apparatus 100 develops the game program which has been stored in the storage device 204 and so forth on the memory 203 and executes it under the control of the control unit 201 and the various configurations that the game apparatus 100 has are controlled, and thereby this game is realized.

First, the player puts the card that he holds into the card reading device 104 of the game apparatus 100 and/or puts a coin into the bill putting-in device 105 in order to start the game. When the card or the coin has been put into it, it becomes possible for the player to hold credit according to the card balance or the coin in the game.

Then, the game apparatus 100 makes a bet screen through which the player bets on the slot game display on the display device 102. The game apparatus 100 starts the slot game in accordance with betting and start instructions by the player. In the following description, the game playing of which becomes possible by putting the coin and so forth into it so as to pay money for it in this way will be called a “normal game” (a first game). On the other hand, a game playing of which becomes possible free of charge without paying money for it will be called a “free game (a second game) in the following description. In addition, in relation to a probability that a privilege is granted (a winning ticket is drawn) in accordance with the game result, the probability which is higher than that for the normal game is set for the free game.

In the normal game or the free game, first, the game apparatus 100 rotates a plurality of virtual reels (for example, 5 reels. In the following, the virtual reels will be also called the “reels” simply) and stops rotation at a random timing reel by reel. After stopped, a part of each reel is displayed on the display device 102.

An exemplary screen 30 to be displayed on the display device 102 is illustrated in FIG. 3. A region 30a is included in the screen 30. An example of display of symbols (patterns) indicated on the part of each reel after rotation of the reels has been stopped is illustrated in the region 30a. In this example, the display device 102 displays 5 reels of reels 31 to 35 in the region 30a. 4 symbols are displayed on each reel. In addition, a plurality of kinds of symbols is displayed on the reel and symbols S1, S2, S3, S4 are displayed in this example.

Various privileges are granted to the player in accordance with whether a way of arraying the symbols which have been displayed on the display device 102 in this way after rotation of the reels has been stopped follows a line (a pay line) which has been set in advance (or selected) or not. In addition, points (values of parameters) are accumulated in accordance with a number that the predetermined symbol has been displayed on the display device 102 after rotation of the reels has been stopped and the various privileges are granted to the player in accordance with the accumulated points concerned.

Though there is no particular limitation, for example, the credit and the free game are granted as the privileges. In addition, the privileges of various values from a big win to a small win are set in accordance with the arrangement and the kinds of the symbols which have been displayed.

The free game will be further described. When the arrangement and the kinds of the symbols which have been displayed on the display device 102 after spinning of the reels has been stopped in the normal game have satisfied a predetermined condition, the game apparatus 100 shifts to a state of making playing of the free game possible. That is, when the arrangement of the symbols displayed and the points so accumulated as described above have satisfied the predetermined condition, the right to play the free game is granted to the player. The above-mentioned predetermined condition will be described later. Thereafter, it becomes possible for the player to continuously play the free game the predetermined number of times (for example, 5 times). Also in the free game, various privileges such as the credit, retrigger and so forth are granted to the player in accordance the way of arraying the symbols and the arrangement of the predetermined symbols after rotation of the reels has been stopped. Here, the retrigger is the privilege that it becomes possible to play the free game further the predetermined number of times (for example, 5 times).

When playing of all the free games is completed, the game apparatus 100 again shifts to the state of making playing of the normal game possible. Incidentally, the time from when betting or the start instructions by the player becomes possible until when presence/absence of granting of the privilege becomes clear in accordance with the stop positions of the reels is defined as one game unit. After presence/absence of granting of the privilege in a certain game has become clear, it becomes possible for the player to make a bet or to perform instructions of the start in the next game.

In the following, the progress of shifting from the normal game to the state of making playing of the free game possible will be described in more detail. First, the display apparatus 100 is, when the arrangement and the kinds of the symbols which have been displayed on the display device 102 when spinning of the reels has been stopped in the normal game have satisfied the predetermined condition, the game apparatus 100 displays a screen for performing lots-drawing on the display device 102. For example, it is possible to set the time that the 5 predetermined symbols (for example, “7”) have been displayed side by side when rotation of the reels has been stopped as the condition concerned.

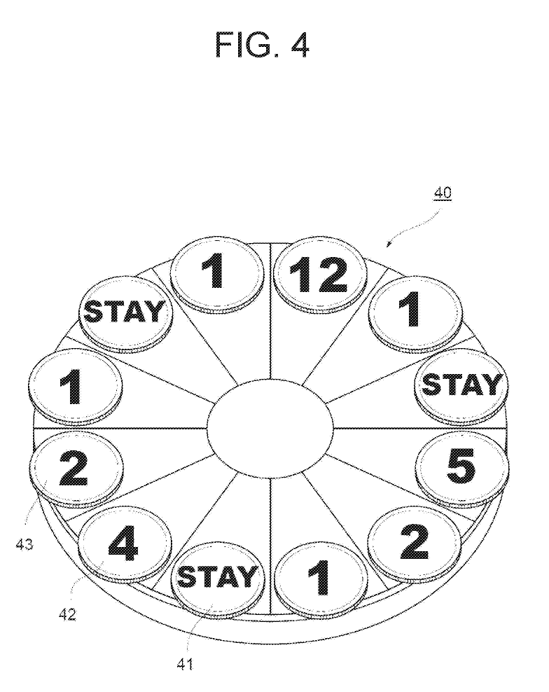

When the above-mentioned condition has been satisfied, the game apparatus 100 performs lots-drawing. FIG. 4 exemplifies a screen 40 to be displayed on the display device 102 when performing the lots-drawing concerned. On the screen 40, objects such as objects 41, 42, 43 and so forth are indicated. A numerical value (for example, 0 to 12) is allocated in advance to each object and the allocated numerical value concerned is displayed on each object. Incidentally, in the example in the drawing, “STAY” corresponds to 0. In order to start lots-drawing, first, the game apparatus 100 reproduces a video image that each object displayed on the screen 40 has been turned back and therefore it has shifted to a state where the numerical values and “STAY” are not displayed on the display device 102. Thereafter, the game apparatus 100 reproduces a video image that the objects concerned move irregularly and thereby are mixed together and shuffled on the display device 102. Thereafter, an object is selected in accordance with the operation by the player and the numerical value which has been allocated in advance to the selected object concerned is determined as a result of lots-drawing. Incidentally, a method of determining the numerical value by lots-drawing is not limited to this and an optional method may be adopted.

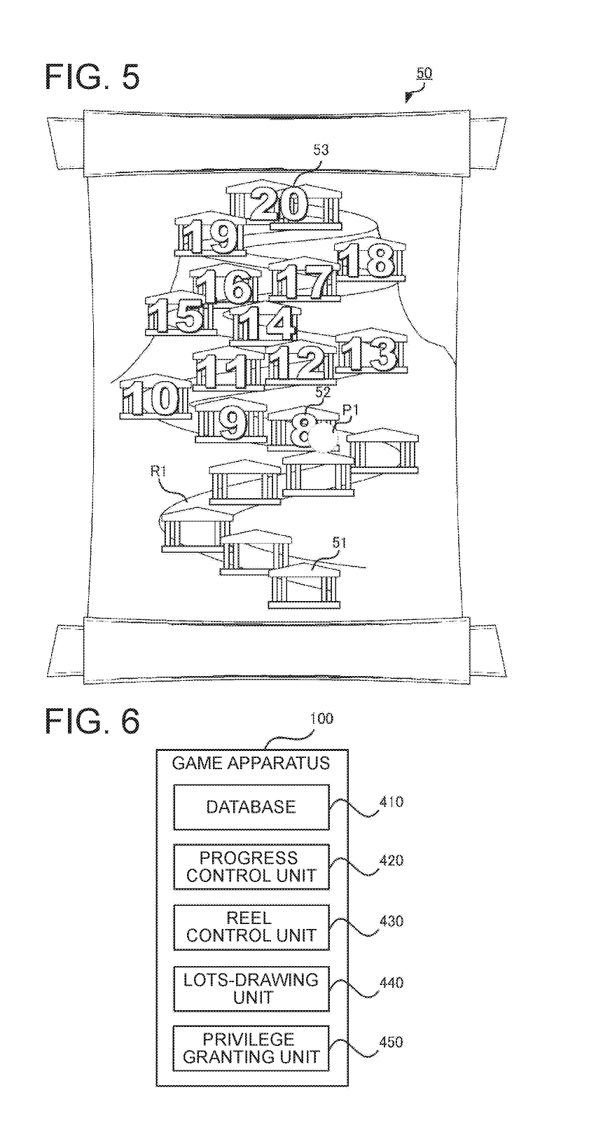

After lots-drawing, the game apparatus 100 determines a number of times that playing of the free game is possible in accordance with the result of lots-drawing. FIG. 5 exemplifies a screen 50 to be displayed on the display device 102 when the number of times that playing of the free game is possible is determined.

In FIG. 5, objects such as objects 51, 51, 53 and so forth which have been arranged on a route R1 are illustrated. A numerical value is set in correspondence with each object in advance. The game apparatus 100 moves an icon P1 from the position of the object 51 which has been arranged on the lowermost part of the route R1 upward in accordance with the numerical value which has been determined by the above-mentioned lots-drawing and determines the numerical value which has been set in correspondence with the object at the position after moved as the number of times that playing of the free game is possible. For example, in a case where the numerical value “2” is set in correspondence with the object 51 and the numerical value which has been determined by the above-mentioned lots-drawing is “6”, the position of the icon P1 is moved from the position of the object 51 to that of the object 52 which is 6 objects away from it in an upward direction along the route R1. At this time, the game apparatus 100 determines the numerical value “8” which has been set in correspondence with the object 52 as the number of times that playing of the free game is possible and grants the right to play the free game 8 times to the player.

In addition, when the condition that the right to play the free game is granted to the player has been again satisfied in a game result of the later free game, the above-mentioned lots-drawing is again performed. In this case, when the position of the icon P1 is to be moved in accordance with the result of the lots-drawing, the start point of the movement concerned is set at the position of the object 52. Accordingly, when the numerical value which has been determined by lots-drawing is, for example, “2”, the game apparatus 100 determines the numerical value (“10”) which has been set in correspondence with the object which is at the position which has been moved upward 2 objects away from the position of the object 52 as the number of times that playing of the free game is possible and grants the right to play the free game 10 times to the player. Incidentally, when the numerical value which has been determined by lots-drawing is “0”, the game apparatus 100 determines the numerical value (“8”) which has been set in correspondence with the position of the object 52 as the number of times that playing of the free game is possible.

There is the possibility that the number of times that the free game is played is increased every time the right is granted in this way. In addition, in the present embodiment, the upper limit value of the number of times that playing of the free game to which the right is granted is possible is “20” which is the numerical value which has been set in correspondence with the uppermost object 53 on the route R1.

### Functional Configuration Examples of the Game Apparatus

Next, examples of the functional configurations of the game apparatus 100 of the present embodiment will be described.

FIG. 6 is a block diagram illustrating the functional configurations of the game apparatus 100 of the present embodiment. As illustrated in the drawing, the game apparatus 100 mainly possesses a database 410, a progress control unit 420, a reel control unit 430, a lots-drawing unit 440, and a privilege granting unit 450 as the functional configurations. For example, the control unit 201 develops the game program which has been stored in a storage unit such as the storage device 204 and so forth on the memory 203 and executes it and thereby these functional configurations are realized by cooperation between the program (the software) and the hardware that the game apparatus 100 has. Incidentally, although the game apparatus 100 has other functions that a general game apparatus has, other than the functions illustrated in FIG. 6, description thereof is omitted here.

The database 410 stores various kinds of information such as information which is necessary for processes executed by the game apparatus 100 and information which has been generated by the processes concerned and so forth. The database 410 stores, for example, a control program for controlling the progress of the game, image (for example, the still image, the moving image, the video image and so forth) data and sound data for expressing and dramatizing the game, and data pertaining to the state of the game which is in progress and so forth.

The progress control unit 420 performs a process for controlling the progress of the game in accordance with the operation to the game apparatus 100 by the player of the game and the control program stored in the database 410. In particular, the progress control unit 420 performs control of the progress of the normal game, control of switching from the normal game to the free game, control of the progress of the free game and control of switching from the free game to the normal game of the slot such as that described in the above-mentioned example of the game contents.

For example, the progress control unit 420 controls the privilege granting unit 450 which will be described later so as to enter the state of making playing of the free game possible or so as to grant the right to play the free game to the player at a desired timing when the arrangement and so forth of the symbols which have been displayed on the display device 102 after rotation of the reels has been stopped in the normal game satisfy the predetermined condition. When it has entered the state of making playing of the free game possible, the progress control unit 420 controls so as to continuously execute the free game the predetermined number of times (for example, 8 times). Here, granting of the right to play the free game to the player specifically means that the privilege granting unit 450 stores data indicating that it is possible for the player concerned to play the free game into the database 410 in accordance with, for example, the control of the progress control unit 420.

Thereafter, the progress control unit 420 refers to the database 410 and specifies whether it is possible for the player concerned to play the free game or not on the basis of the data concerned and, in a case where it is possible, controls playing of the free game. In addition, the above-mentioned controls by the progress control unit 420 are performed in accordance with results of the processes by the reel control unit 430, the lots-drawing unit 440 and the privilege granting unit 450 which will be described later.

The reel control unit 430 controls spinning and stopping of the reels and display of the video image of the reels concerned on the display device 102 in the slot game. The images of the plurality of symbols are indicted on the surfaces of the reels and the reel control unit 430 controls so as to display some symbols in the plurality of symbols concerned on the display device 102.

While the reels are spinning, the reel control unit 430 displays the symbols indicated at the positions according to spinning in the plurality of symbols indicated on the reels while sequentially scrolling them and thereby sequentially changes the display on the display device 102. Thereafter, the reel control unit 430 controls so as to stop scrolling of the display by stopping spinning of the reels at the predetermined timing. The reel control unit 430 is capable of determining, for example, the stopping positions of the reels randomly.

In the case of the example illustrated in FIG. 3, the reel control unit 430 controls spinning and stopping of each of the 5 reels. In addition, in FIG. 3, in the plurality of the symbols indicated on one reel, 4 symbols are displayed on the display device 102. Accordingly, in this example, in the plurality of symbols indicated on the 5 reels, 20 symbols in total are displayed on the display device 102 by the control of the reel control unit 430. That is, the reel control unit 430 functions as symbol display control means adapted to control so as to display one or the plurality of symbol(s) on the display device 102 randomly.

The lots-drawing unit 440 controls so as to perform lots-drawing in accordance with the game result of the normal game (the first game) or the free game (the second game). Specifically, the lots-drawing unit 440 is capable of determining the numerical value (for example, any of 1 to 12) selected by lots-drawing when the condition that the right to play the free game is granted to the player has been satisfied such as an occasion that the 5 predetermined symbols (for example, “7”) have been displayed side by side on the display device 102 when rotation of the reels has been stopped and so forth. The lots-drawing unit 440 is capable of determining the numerical value, for example, on the basis of an output result of a random number generator. The more specific example of the lots drawing method which is performed by the control of the lots-drawing unit 440 is as described above with reference to FIG. 4.

The privilege granting unit 450 controls so as to grant the right to continuously play the free game the number of times which is not less than the number of times that the free game has been continuously played at the previous time in accordance with a result of lots-drawing by the lots-drawing unit 440. As a specific process for granting the right concerned, the privilege granting unit 450 stores data indicating that it is possible for the player who accepts grant of the right concerned to play the free game into the database 410. Thereafter, when the database 410 is referred to at the predetermined timing and it has been decided that it is possible for the player concerned to play the free game, the free game is started.

As a method of granting the right concerned, for example, it is assumed that the number of times (the number of times of playing under the right to play the free game which has been granted at the previous time) that a certain player has continuously played the free game at the previous time is “3”. At this time, the privilege granting unit 450 controls so as to grant the right to continuously play the free games the number of times which is more than “3” to the player concerned on the basis of the result of lots-drawing by the lots-drawing unit 440 according to the game result of the normal game. In this example, in a case where the numerical value which has been determined by lots-drawing by the lots-drawing unit 440 is “5”, the privilege granting unit 450 is capable of controlling so as to grant the right to continuously play the free game 8 (=3+5) times to the player.

In addition, it is assumed that the number of times of playing under the right to continuously play the free game that the privilege granting unit 450 has granted at the previous time is “8” and the game result of the free game has satisfied the condition that the above-mentioned right is granted to the player. At this time, the privilege granting unit 450 is capable of controlling so as to grant the right to continuously play the free game the number of times which is more than “8” to the player in accordance with the result of lots-drawing by the lots-drawing unit 440. In this example, in a case where the numerical value which has been determined by lots-drawing by the lots-drawing unit 440 is “2”, the privilege grating unit 450 is capable of controlling so as to grant the right to continuously play the free game 10 times (=8+2) to the player. That is, the privilege granting unit 450 grants the right to continuously play the free game (the second game) in accordance with the result of lots-drawing and thereafter in a case where the play result of the free game has satisfied the predetermined condition, it grants the right to continuously play the free game the number of times which is not less than the number of times that the free game is continuously played under the right which has been granted at the previous time to the player

Incidentally, when the right to continuously play the free game is granted to the player, the privilege granting unit 450 stores information on the number of times that the free game is played under the right concerned into the database 410. Thereafter, when the right to further continuously play the free game is granted to the player concerned, the privilege granting unit 450 is capable of specifying the number of times of playing under the right to continuously play the free game which has been granted at the previous time by referring to the database 410.

In addition, in a case where the right to continuously play the free game is granted to the player concerned for the first time, the privilege grating unit 450 is capable of controlling so as to grant the right to continuously play the free game the number of times (for example, 5 times) which has been set as an initial value to the player concerned.

The number of times of playing under the right to play the free game which is granted by the privilege granting unit 450 as mentioned above is set so as to become more than or equal to the number of times of playing under the right which has been granted at the previous time every time the right is granted. As a result, the player is able to obtain a more valuable privilege (a right to play the free games a larger number of times) as he keeps playing the game. Accordingly, according to the present embodiment, it is possible to realize the game of higher entertaining property.

Incidentally, it is possible to set the upper limit value (for example, 20 times) to the number of times of playing under the right to play the free game which is granted by the privilege granting unit 450 and it is controllable so as not to grant a right to play it a number of times exceeding the upper limit value concerned.

### Process Flow

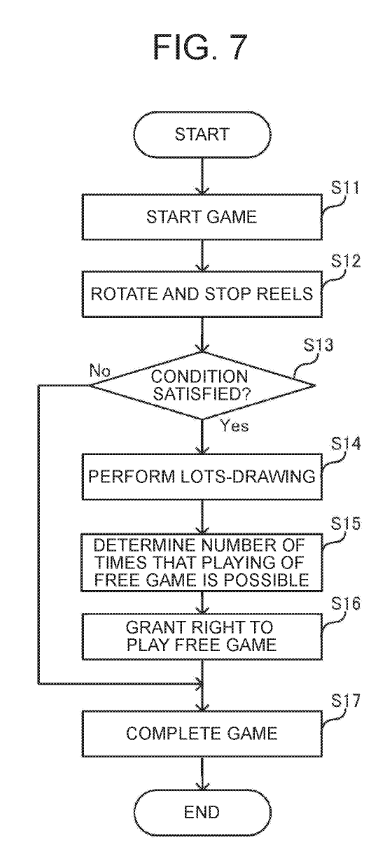

Next, a flow of a process of granting the right to play the free game in the slot game (the normal game or the free game) in the processing executed in the game apparatus 100 will be described with reference to FIG. 7.

The control unit 201 develops the program stored in the storage device 204 and so forth on the memory 203 and performs execution thereof and so forth and thereby this process is executed by cooperation between the program (the software) and the hardware that the game apparatus 100 has. Incidentally, it is possible to execute respective process steps included in the process flow which will be described in the following by optionally changing the order or in parallel with one another within a range not inducing a contradiction in process details. In addition, another step may be added between the respective process steps within the range not inducing the contradiction in process details. In addition, it is possible to execute the step which is described as one step for convenience by dividing into the plurality of steps and, on the other hand, it is possible to grasp the one which is described by being divided into the plurality of steps for convenience as one step. Incidentally, since the process details of the respective process steps have already been described, it is omitted here.

First, in step S11, the control unit 201 starts execution of the slot game in accordance with bet putting-in and operation instructions of the game to the game apparatus 100 by the player and moves the game forward. That is, it controls execution of the game. Thereafter, the process proceeds to step S12. Incidentally, the slot game concerned may be the normal game or the free game. When it is the free game, bit putting-in for starting it is not needed.

In step S12, the control unit 201 controls so as to spin the plurality of reels (for example, 5 reels) and to display the video image that spinning concerned has been stopped at the predetermined timing on the display device 102. The plurality of symbols is indicated on each reel. When the reels are spinning, the control unit 201 controls so as to display the symbols indicated at the positions according to the state of spinning in the plurality of symbols indicated on the reels on the display device 102 while scrolling them sequentially and so as to stop scrolling for display at the predetermined timing. The control unit 201 writes the game result which is based on the arrangement and so forth of the symbols which have been displayed on the display device 102 after the scrolling concerned has been stopped into the storage device 204. Thereafter, the process proceeds to step S13.

In step S13, the control unit 201 reads the game result out of the storage device 204 and decides whether the arrangement and so forth of the symbols which have been displayed on the display device 102 after scrolling (spinning of the reels) for symbol display has been stopped satisfy the predetermined condition or not. For example, that the 5 predetermined symbols (for example “7”) have been displayed side by side on the display device 102 may be set as the predetermined condition concerned. In a case where the condition concerned is satisfied (Yes in step S13), the process proceeds to step S14, and in a case where the condition concerned is not satisfied (No in step S13), the process proceeds to step S17.

In step S14, the control unit 201 determines the numerical value (for example, any of 1 to 12) which has been selected by lots-drawing. Specifically, the control unit 201 executes a random number operation and determines the numerical value on the basis of a result of the operation concerned. The control unit 201 writes the determined numerical value concerned into the storage device 204 as a result of lots-drawing. Thereafter, the process proceeds to step S15.

In step S15, the control unit 201 reads the result of lots-drawing and the number of times that the free game has been continuously played at the previous time out of the storage device 204 and determines the number of time that continuous playing of the free game is possible this time. The number of times that continuous playing is possible this time is determined to become the number of times which is more than or equal to the number of times that the free game has been continuously played at the previous time. Incidentally, in a case where the right to continuously play the free game is granted to the player concerned for the first time, the control unit 201 determines such that the number of times that continuous playing of the free game is possible becomes the number of times (for example, 5 times) which has been set as the initial value. Thereafter, the process proceeds to step S16.

In step S16, the control unit 201 controls so as to grant the right to continuously play the free game the number of times which has been determined in step S15 to the player. As a specific process for granting the right concerned, the control unit 201 stores flag data indicating that the player who will accept grant of the right concerned is able to utilize the right concerned (that the specific right is effective) into the storage device 204. In addition, it stores the number of times which has been determined in step S15 into the storage device 204 in correspondence with the flag data concerned. The control unit 201 decides whether it is possible for the target player to play the free game or not on the basis of the flag data written into the storage device 204 at a later predetermined timing and starts execution of the free game when it has been decided to be possible. Thereafter, the control unit 201 writes the number of times that the free game has been continuously played this time as the number of times that the free game has been continuously played at the previous time into the storage device 204.

In step S17, the control unit 201 performs a predetermined process for completing the game and the process illustrated in FIG. 7 is completed.

As described above, according to the present embodiment, the number of times of playing under the right to play the free game to be granted is set so as to become more than or equal to that every time the right concerned is granted. As a result, it becomes possible for the player to obtain a more valuable privilege (the right to play the free game a larger number of times) as he keeps playing the game. Accordingly, according to the present embodiment, it is possible to realize the game of higher entertaining property.

### Altered Example

The present disclosure is not limited to the above-mentioned embodiments and may be performed by adding various alterations within a range not deviating from the gist of the present disclosure. That is, the above-mentioned embodiments are merely illustrative in all respects, shall not be interpreted limitedly and may adopt various altered examples.

For example, although in the above-mentioned embodiments, the slot game has been adopted as the game playing of which is possible by the game apparatus 100, optional games such as baccarat, blackjack and so forth may be adopted not limited to this.

### TABLE OF REFERENCE NUMERALS

100 game apparatus
101 loudspeaker
102 display device
103 operation input device
104 card reading device
105 bill putting-in device
106 ticket ejecting device
201 control unit
202 CPU
203 memory
204 storage device
205 voice processing unit
206 image processing unit
207 communication unit
208 peripheral device interface

1. A game apparatus comprising a control unit and a storage unit, wherein the control unit is configured to execute a program stored in the storage unit and thereby to realize:
a lots-drawing function of performing lots-drawing in accordance with a game result of a first game; and
a granting function of granting a right to continuously play a second game in accordance with a result of the lots-drawing
and thereafter in a case where a play result of the second game has satisfied a predetermined condition, granting a right to continuously play the second game a number of times which is not less than a number of times that the second game is continuously played under the right which has been granted at the previous time.

2. The game apparatus according to claim 1, wherein
the lots-drawing function determines a numerical value by the lots-drawing, and
the granting function grants a right to continuously play the second game a number of times that the determined numerical value has been added to the number of times that the second game is continuously played under the right which has been granted at the previous time in accordance with a result of the lots-drawing.

3. The game apparatus according to claim 1, wherein
a probability that a privilege is granted in accordance with the game result of the second game is higher than a probability that the privilege is granted in accordance with the game result of the first game.

4. The game apparatus according to claim 1, wherein
the number of times that the second game is continuously played under the right which is granted by the granting function has an upper limit value.

5. A game apparatus comprising:
a control unit; and
a storage unit out of/into which data reading and writing are made from the control unit, wherein
the control unit is programmed:
to control execution of a first game,
to write a game result of the first game into the storage unit,
to read the game result of the first game out of the storage unit;
to execute a random number operation in a case where the game result has matched a predetermined condition,
to write a result of the random number operation into the storage unit as a result of lots-drawing,
to read the written result of the lots-drawing out of the storage unit,
to grant a right to continuously play a second game in accordance with the read-out result of the lots-drawing, and thereafter, in a case where a play result of the second game has satisfied a predetermined condition, to write a number of times which is not less than a number of times that the second game is continuously played under the granted right and a flag indicating that the right to continuously play the second game is effective,
to read data out of the storage unit, in a case where the flag is included in the read-out data concerned, to read the written number of times out of the storage unit and to control to continuously execute the second game the read-out number of times, and
to write the number of times that the second game has been continuously executed this time as a number of times that the second game has been continuously executed at the previous time into the storage unit.

6. A game controlling method performed in a game apparatus which comprises a control unit and a storage unit, the method performing, by the control unit executing a program stored in the storage unit, steps of:
the lots-drawing step of performing lots-drawing in accordance with a game result of a first game; and
the granting step of grating a right to continuously play a second game in accordance with a result of the lots-drawing, and in a case where a play result of the second game has satisfied a predetermined condition, granting a right to continuously play the second game a number of times which is not less than a number of times that the second game is continuously played under the right which has been granted at the previous time.
